(19) United States
(12) Patent Application Publication
(10) Pub. No.: US 2007/0273506 A1
(43) Pub. Date: Nov. 29, 2007

(54) REMOTE NOTIFICATION SYSTEM

(75) Inventor: Jeffrey H. Butler, Gilbert, AZ (US)

Correspondence Address: WOOD, HERRON & EVANS, LLP, 2700 CAREW TOWER, 441 VINE STREET, CINCINNATI, OH, 45202, US

(73) Assignee: Jeffrey H. Butler, Gilbert, AZ (US)

(21) Appl. No.: 11/420,342

(22) Filed: May 25, 2006

(51) Int. Cl. G08B 1/08; H04Q 7/00

(52) U.S. Cl. 340/539.18; 340/539.16

(57) ABSTRACT

A personal alarm system characterized by a central control or base unit wirelessly connected to one or more remote personal alarm units. The central control unit stores one or more alarms and is configured to transmit alarm notifications to one or more of the remote personal alarm units. Each remote personal alarm unit is in a convenient form for individual use.

### FIELD OF THE INVENTION

The invention is generally directed to personal alarm and notification systems, and in particular to notification systems supporting remote notification functionality.

### BACKGROUND OF THE INVENTION

Alarm clocks have long been used by individuals to wake themselves up in the morning or at other times of the day. Typically, a user is able to set a specific time of day for an alarm, whereby the alarm clock will typically generate a loud noise such as a beep to wake up the user at the desired time. Some alarm clocks also include an AM/FM radio and/or a CD player, and permit either a radio station or a CD to be played back to the user in lieu of a beep. Other consumer devices may also support alarm functionality, e.g., cell phones, PDA's, electronic watches, personal computers, etc.

One limitation of existing alarm clocks and like devices, however, is that the audible alarm broadcast thereby is generated at the device, thereby requiring the individual being woken up to be in close proximity with the device. Furthermore, while some devices support the ability to set multiple alarms for different individuals, if those individuals are located in the same location (e.g., sleeping in the same bed), each individual will hear every audible alarm since all alarms are broadcast from the device. For example, when two individuals need to wake up at different times to go to work, and one sets an alarm that is earlier than when the other needs to get up, the individual who doesn't need to wake up as early often will still be woken up by the earlier alarm.

### SUMMARY OF THE INVENTION

The invention addresses these and other problems associated with the prior art by providing a remote notification system having functionality that allows a user to program a timed event into a base unit (BU), which upon occurrence of the timed event, sends a message to or otherwise controls one or more remote receiving units (RU's) to provide a remote notification of the timed event.

In one implementation of the invention, the BU is the “central control” of the system and supports the basic features of a classic alarm clock, with additional features to accommodate remote notification. The basic features may include, for example, an AM/FM radio, a flash memory music player and/or an optical disc (e.g., CD or DVD) player, a time display, an alarm, and relatively basic “feature setting” capability. Additional features allow for communication between the BU and the RU's. Communication from the BU to the RU(s) may be unidirectional, i.e. where the BU is transmit only and each RU is configured to only receive BU transmissions, or alternatively, bidirectional communication may be supported. The BU in this implementation may additionally support the ability to program unique RU identifications (IDs) to support wireless transmission of notifications to individual RU's.

Each RU may be configured to receive a wireless communication from the BU, and may support multiple alarm modes, e.g., sonic/audible, visual display and/or vibrating. Each RU may also support “alarm off” and “alarm mode” selection functionality. Furthermore, each RU may be configured to be wearable by an individual, e.g., via an associated wristband.

These and other advantages and features, which characterize the invention, are set forth in the claims annexed hereto and forming a further part hereof. However, for a better understanding of the invention, and of the advantages and objectives attained through its use, reference should be made to the Drawings, and to the accompanying descriptive matter, in which there is described exemplary embodiments of the invention.

### BRIEF DESCRIPTION OF THE DRAWINGS

FIG. 1 shows the overall functionality associated with a Base Unit component of a Remote Notification System consistent with the invention.

FIGS. 2A and 2B show alternative implementations of the overall functionality associated with a Receive Unit component of the Remote Notification System of FIG. 1.

FIG. 3 is a block diagram of one circuit arrangement suitable for implementing the Base Unit of FIG. 1, illustrating time/alarm entry and signal output functionality therefor.

FIG. 4 is a block diagram of the circuit arrangement of FIG. 3, illustrating information entry functionality therefor.

FIG. 5 is a block diagram of one circuit arrangement suitable for implementing the Receive Unit of FIGS. 2A and 2B.

### DETAILED DESCRIPTION

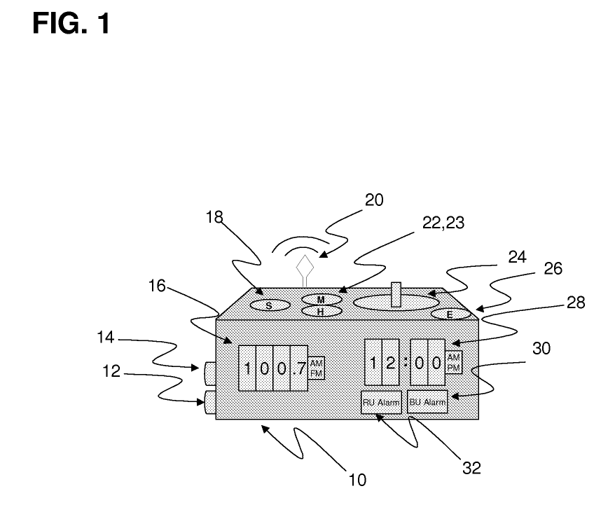

Reference shall be made to the drawings in which the same reference numbers are used throughout the different figures to designate the same components. FIG. 1 shows the overall functionality associated with a Base Unit (BU) component 10 of a Remote Notification System consistent with the invention. Base Unit 10 is implemented in this embodiment as an alarm clock comprised of multiple features, e.g., a radio tuner 12, a volume control 14, a radio tuner display 16, a snooze button 18, an antenna 20, minute/hour set buttons 22, 23, a mode switch 24, an enter switch 26, a time display 28, and BU and RU alarm on indicators 30, 32. Base Unit 10 may additionally incorporate any alternate configuration or functionality utilized in conventional alarm clocks and associated devices. For example, the base unit may include a backup power source such as a battery to maintain settings in the event of a power loss. The base unit may also include a receiver for receiving a time of day signal such as an atomic clock signal. In addition, for local alerts generated by the base unit itself, the alert may take the form of an audible beep or buzzer, or the alert may incorporate the activation of the radio tuner, or alternatively, an optical disc player (e.g., a CD or DVD player) or flash memory music player (e.g., an MP3 player), as with conventional alarm clocks.

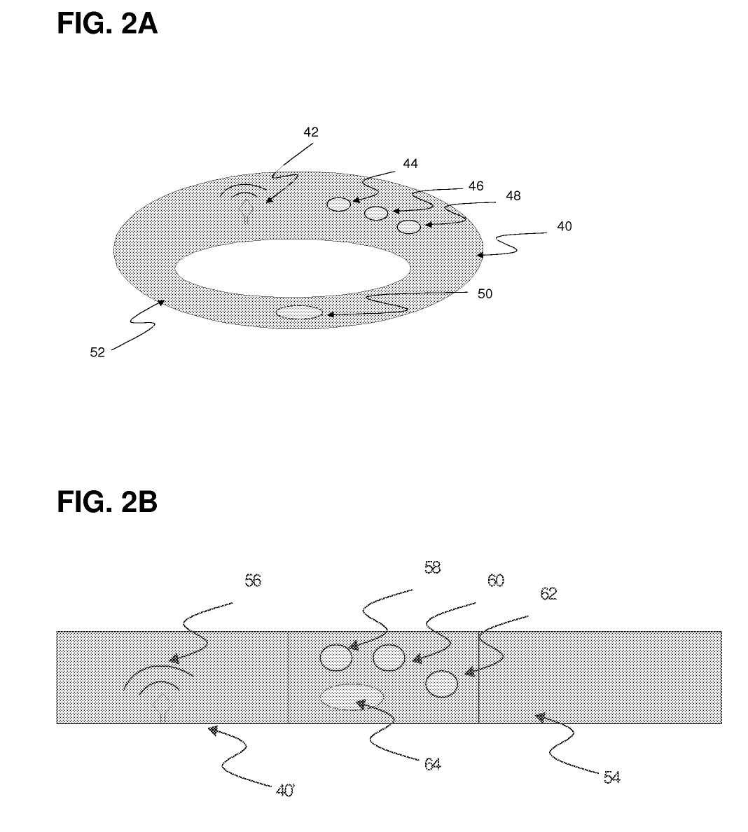

FIG. 2A shows the overall functionality associated with one suitable implementation of a Receive Unit (RU) component 40 for the Remote Notification System. The Receive Unit 40 is comprised of multiple features such as an antenna 42, an alarm off switch 44, an alarm mode select switch 46, an alarm set indicator 48, and a battery compartment 50, each disposed within a wristband form factor 52. In this embodiment, the wristband is continuous in nature, and to this extent is similar in nature to a bracelet. The wristband may also be elastic or otherwise expandable to permit the receiver unit to pass over the hand of the user yet be retained securely on the user's wrist. It will be appreciated that different combinations of control buttons may be used on each RU, and that an RU may use different form factors, and may or may not be wearable. For example, FIG. 2B shows an alternate Receive Unit 40′ incorporating a separable or non-contiguous wristband 54 upon which is disposed an antenna 56, an alarm off switch 58, an alarm mode select switch 60, an alarm set indicator 62, and a battery compartment 64. Various manners of affixing the ends of wristband 54 to one another, e.g., a clasp, hook and loop fastener, a buckle, etc., may be used consistent with the invention.

Other manners of making an RU wearable may also be used in the alternative, e.g., via a necklace, a clip, a leg-band, adhesive, etc. In addition, an RU may be embedded in or otherwise coupled to another item, e.g., apparel.

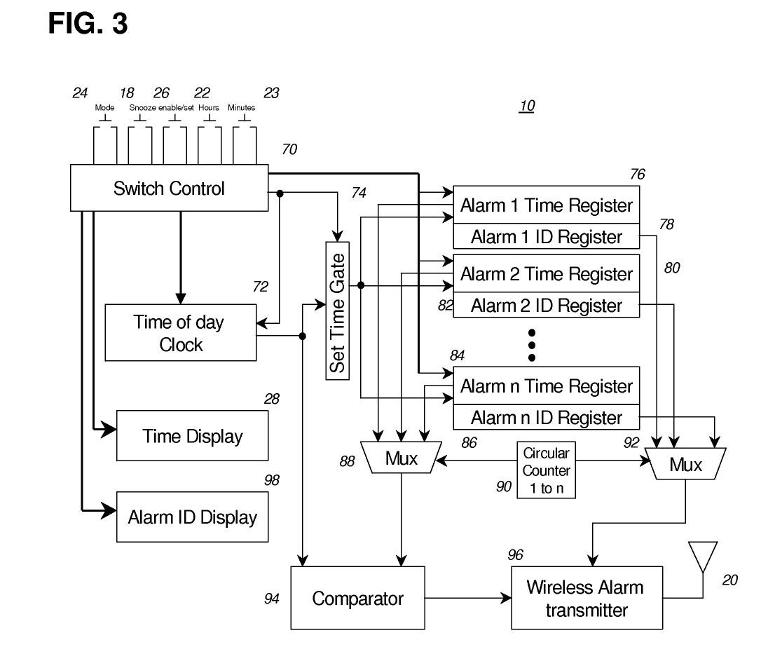

FIG. 3 is a block diagram of one implementation of a circuit arrangement suitable for controlling the operation of BU 10, and illustrates the functionality that may be provided in such a circuit arrangement for programming events and determining when a wireless alarm signal is sent out. In particular, Mode switch 24 is used to toggle through all operational modes such as “Set time of day”, “Alarm 1—Time” and “Alarm 1—Enable”, “Alarm 2—Time” and “Alarm 2—Enable”, and “Alarm n—Time” and “Alarm n—Enable”.

The time of day setting is enabled by the use of mode switch 24 that of which puts a switch control block 70 into “Set Time of Day” mode, which modifies the Time of day clock 72 using the hour switch 22 and minute switch 23. Once the expected time is displayed, the time is set, as the time of day clock is always running.

Each alarm register pair is related to a unique RU by the unique RU ID stored in identifier registers 78, 82, 86. The RU ID may be implemented as an address, or by any other identifier, e.g., a numeric code, an alphanumeric code, etc. The time registers 76, 80, 84 are individually selected and updated by setting the update mode using the Mode Switch 24 in combination with hour switch 22 and minute switch 23, thru Set Time Gate 74.

The Comparator 94 is used to compare the current time of day 72 with each alarm register set time of 76, 80, 84 via mux 88. Each time register 76, 80, 84 is selected by a circular 1 to n counter 90, which is configured to cycle through each of n register pairs on a periodic basis, e.g., once a minute. If the comparator 94 gets a match between the time of clock 72 and any one of the alarm time registers 76, 80, 84, then an alert signal is sent to the Wireless Alarm Transmitter 96. Selection of the appropriate RU to notify is performed by mux 92, which is also driven by counter 90, and which passes the associated ID address for the RU for which the alarm time matches, stored in the respective identifier register 78, 82, 86.

Transmitter 96 generates a notification signal having encoded therein the ID address for the RU to be notified of the alarm condition. As such, all RU's receive the notification signal. Each RU is configured to decode the ID address from the notification signal such that only the intended RU will signal the alarm. In other embodiments, however, an RU ID may be associated with a particular frequency or protocol such that only the appropriate RU will be responsive to the notification signal. In such an instance, the ID address may be used to configure wireless transmitter 96 to generate the appropriate notification signal.

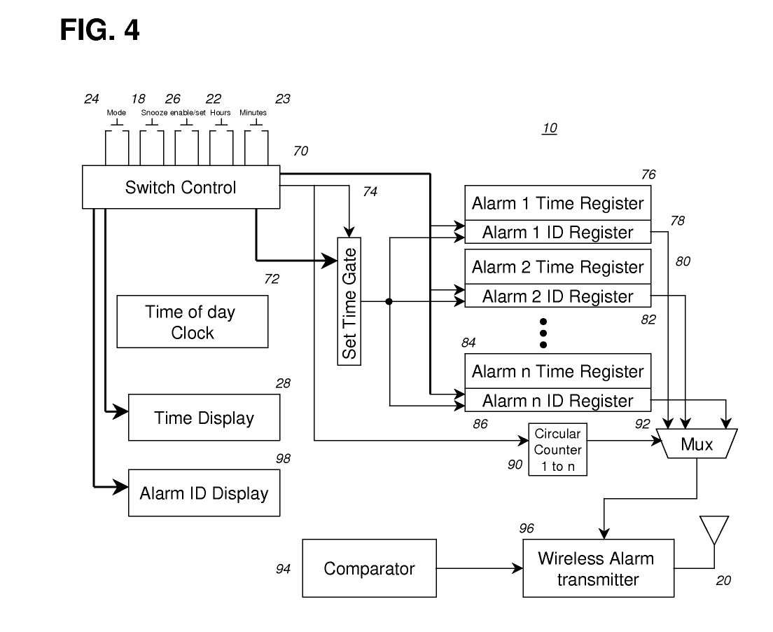

FIG. 4 is a block diagram illustrating how Base Unit 10 may be used to enter the ID of an RU into an appropriate ID register. Each receiver unit 40 comes preprogrammed with an ID number. Each alarm ID register 78, 82, 86 must be programmed with the ID of each RU. Mode switch 24 is used to put the BU 10 in an RU ID program mode. Hour switch 22 and minute switch 23 may be used to allow input of the appropriate RU ID address.

An alarm ID display 98 will display the RU ID being programmed. The alarm display 98 will be reflective of the selected RU unit ID stored in alarm register 78, 82, 86. In the alternative, the tuner display 16 or the time display 28 may be used to display RU unit ID information.

It may also be desirable to assign a register pair to the base unit 10 such that one or more register pairs may be used to provide the local notification functionality for the device. In such an instance, a local alarm signal would be generated in lieu of outputting a wireless signal via transmitter 96. In the alternative, separate alarm notification circuitry, e.g., as used on conventional alarm clocks, may be used to handle local alarm notifications.

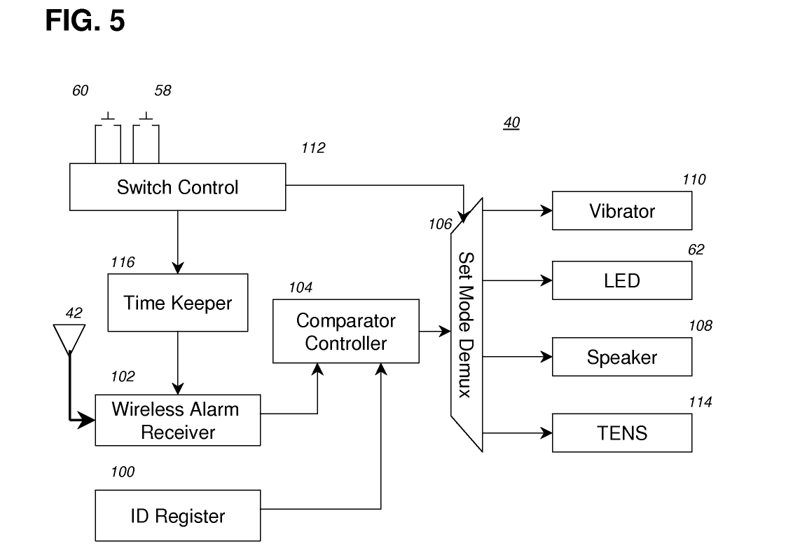

FIG. 5 is the block diagram of one implementation of a circuit arrangement suitable for controlling the operation of an RU 40. Its pre-defined RU ID is stored in ID register 100. When a wireless alarm receiver 102 receives an RU ID signal from the BU, it is compared to the RU ID stored in ID register 100 with comparator controller 104. This result is sent to demux 106.

Each RU can be enabled to use one of four alert modes: sound (provided by a speaker 108), vibrate (provided by a vibrator 110), visual (provided by indicator/LED 62, or by an alternate visual mechanism), or electrical stimulation (provided by stimulator or TENS device 114). The alert mode is set locally in the RU. Alert mode can be chosen thru switch control 112 by using alarm mode switch 60. This result is sent to demux 106. Alternatively, an alert mode may be specified by the base unit and selectable by a user, with the RU notified via the notification signal of the type of alert to generate in response to the notification signal. In addition, audible alerts may simply incorporate beeps, or may include more complex sounds, such as songs or audio clips, e.g., as with conventional ringtones that are utilized on mobile phones.

An active alarm can be disabled thru switch control 112 by depressing alarm off switch 58. A “Snooze mode” can be enabled by depressing and holding alarm mode switch 60 followed by immediately depressing alarm switch 58. This activates time keeper 116 and will temporarily disable the selected alarm mode for a preprogrammed period defined at RU assembly.

It will be appreciated that various modifications may be made to the illustrated embodiments without departing from the spirit and scope of the invention. For example, various communication protocols may be used to implement with wireless notification of receiver units. In addition, it may be desirable to program base unit 10 to permit a register pair to be associated with multiple receiver units, or with the base unit and one or more receiver units, so that multiple notifications may be generated at a given alarm time. It may also be desirable to define a broadcast ID to which all RU's are responsive.

Additional modifications may be made to the illustrated embodiments as will be appreciated by those of ordinary skill in the art. Therefore, the invention lies in the claims hereinafter appended.

What is claimed is:

1. A wireless alarm system, comprising:
a receiver unit including a wireless receiver and configured to generate an alert in response to receiving a notification signal; and
a base unit including a wireless transmitter and configured to store an alarm, wherein the alarm associates the receiver unit with a predetermined time, the base unit further configured to, in response to a current time matching the predetermined time for the alarm, initiate generation of the notification signal by the wireless transmitter.

2. The wireless alarm system of claim 1, wherein the receiver unit is a first receiver unit among a plurality of receiver units, each receiver unit among with plurality of receiver units having an associated identifier, and each receiver unit configured to generate an alert in response to a notification signal only if the notification signal is associated with the identifier for such receiver unit.

3. The wireless alarm system of claim 2, wherein the identifier for each receiver unit comprises an address, wherein the base unit is configured to store the address for the first receiver unit to associate the first receiver unit with the alarm, wherein the base unit is configured to initiate generation of the notification signal by including the address for the first receiver unit in the notification signal, and wherein the first receiver is configured to generate the alert only if the address for the first receiver is detected in the notification signal.

4. The wireless alarm system of claim 3, wherein the base unit includes a plurality of register pairs configured to store a plurality of alarms, each register pair including a time register configured to store a time, and an identifier register configured to store an address for a receiver unit.

5. The wireless alarm system of claim 2, wherein the base unit is further configured to display alarm information for the alarm by displaying the predetermined time and the identifier for the first receiver unit.

6. The wireless alarm system of claim 2, wherein the plurality of receiver units includes a second receiver unit, and wherein the second receiver unit is configured to receive the notification signal and determine that the notification signal does not identify an identifier for the second receiver unit, whereby the second receiver unit does not generate an alert in response to the notification signal.

7. The wireless alarm system of claim 1, wherein the base unit comprises an alarm clock, and wherein the base unit is further configured to generate a local alert in response to a second alarm stored in the base unit.

8. The wireless alarm system of claim 7, wherein the base unit further comprises at least one of a radio, a flash memory music player or an optical disk player.

9. The wireless alarm system of claim 1, wherein the receiver unit is wearable by a user.

10. The wireless alarm system of claim 1, wherein the receiver unit comprises a wristband to permit the receiver unit to be worn on a wrist.

11. The wireless alarm system of claim 1, wherein the receiver unit includes a speaker to generate an audible alert.

12. The wireless alarm system of claim 1, wherein the receiver unit includes an indicator to generate a visible alert.

13. The wireless alarm system of claim 1, wherein the receiver unit includes a vibrator to generate a vibrating alert.

14. The wireless alarm system of claim 1, wherein the receiver unit includes a stimulator to generate electrical stimulation alert.

15. The wireless alarm system of claim 1, wherein the receiver unit is configured to select from among a plurality of alert types in response to user input.

16. An alarm clock, comprising:
a clock;
a wireless transmitter configured to generate a notification signal; and
a control circuit coupled to the clock and the wireless transmitter and configured to store an alarm that associates a predetermined time with a first receiver unit among a plurality of receiver units, the control circuit further configured to initiate generation of a notification signal by the wireless transmitter that will initiate generation of an alert by the first receiver unit but not by at least one other receiver unit not associated with the alarm.

17. A wearable receiver unit for a wireless alarm system, comprising:
a wireless receiver configured to receive a notification signal; and
a control circuit coupled to the wireless receiver and configured to determine whether the notification signal is associated with the receiver unit, and if so, to generate an alert responsive to the notification signal.

18. The receiver unit of claim 17, further comprising a wristband upon which the wireless receiver and the control circuit are disposed.

19. The receiver unit of claim 17, wherein the control circuit is configured to generate the alert by generating at least one of an audible alert, a visual alert, a vibration alert or an electrical stimulation alert.

20. A method of generating an alert, the method comprising:
in a base unit, storing an alarm that associates a predetermined time with a first receiver unit among a plurality of receiver units, determining whether a current time matches the predetermined time for the alarm, and if so, generating a wireless notification signal associated with the first receiver unit; and
in the first receiver unit, detecting the notification signal, determining whether the notification signal is associated with the first receiver unit, and if so, generating an alert.
